(19) United States
(12) Patent Application Publication
(10) Pub. No.: US 2002/0049041 A1
(43) Pub. Date: Apr. 25, 2002

(54) Transceiver for time divison system

(75) Inventors: Paul R. Marshall, Salfords (GB); Kevin R. Boyle, Horsham (GB); Christopher B. Marshall, Haywards Heath (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/969,000

(22) Filed: Oct. 2, 2001

(30) Foreign Application Priority Data
Oct. 20, 2000 (GB) 0025709.7

(51) Int. Cl. H04B 1/44

(52) U.S. Cl. 455/78; 455/83; 455/73

(57) ABSTRACT

A transceiver for use in a time division radio system comprises a transmitter (104) and a receiver (106), each coupled to a different port of an antenna (102). By suitable switching of low impedances between antenna ports and ground, signals can be routed as required between the transmitter, receiver and antenna. In one embodiment the antenna (102) is a folded monopole which is fed at one end while the other end is grounded by switching the appropriate circuitry (114,112) to a low impedance state. In a modification of this embodiment one switch (114) connects the antenna (102) to a DC supply (V_{c}) which provides power for the transmitter when the transceiver is functioning as a transmitter.

Filtering and matching circuitry (502,504) can be inserted as necessary between antenna feed lines (108,110) and the transmission and reception circuitry. In alternative embodiments the antenna may have further ports, with impedance changes at these ports implementing the switching and routing functions.

The present invention relates to a transceiver for use in a time division system, and to such a transceiver implemented as an integrated circuit.

A radio transceiver comprises an output from a transmitter power amplifier, an input to a receiver and an antenna. When the transceiver is receiving energy is directed from the antenna to the receiver input, while when transmitting energy is directed from the transmitter output to the antenna. In a Time Division Multiple Access (TDMA) system, the function of ensuring that energy is routed correctly is often implemented using switches (such as PIN diodes).

Some known TDMA transceivers use suitable choices of impedances, instead of switches, to direct the energy appropriately. For example, when transmitting the impedance looking into the receiver input can be made to produce a reflection thereby ensuring that all of the power from the transmitter output is radiated. Similarly, when receiving the impedance of the transmitter output can be made to produce a reflection, so that the received energy from the antenna flows into the receiver input.

It is well-known that a circuit having a high impedance (i.e. effectively open circuit) will produce a reflection, and such a choice is used for a number of low power radio transceivers. However, this choice does give rise to large voltage swings, which in turn can generate spurious signals via non-linear effects.

An alternative approach is to choose circuit elements which produce a low impedance state (i.e. effectively short circuit). However, in such a circuit a transmission line circuit or equivalent is required in order to map the low impedance to a high impedance at the point of connection of the two signal paths. This results in extra circuit complexity.

An object of the present invention is to provide an improved switching function for a TDMA transceiver.

According to a first aspect of the present invention there is provided a transceiver for use in a time division system, the transceiver comprising transmitter means, receiver means, first connection means for coupling the transmitter means to a first port of an antenna and second connection means for coupling the receiver to a second port of the antenna, wherein first low impedance means are provided for coupling at least one port of the antenna to a radio frequency ground when the transceiver is operating as a transmitter and second low impedance means are provided for coupling at least one port of the antenna to a radio frequency ground when the transceiver is operating as a receiver.

The first and second impedance means may be provided by low impedance switches, each coupling one port of the antenna to a radio frequency ground. Such an arrangement has the advantage of avoiding the need to have switches in the signal path and of being straightforward to implement on chip if the transceiver is implemented as an integrated circuit. By selection of a suitable antenna, such as a folded monopole, which requires one end to be grounded in operation, isolation between transmitter means and receiver means is automatically achieved.

According to a second aspect of the present invention there is provided a transceiver made in accordance with the first aspect of the invention, implemented as an integrated circuit.

Embodiments of the present invention will now be described, by way of example, with reference to the accompanying drawings, wherein:

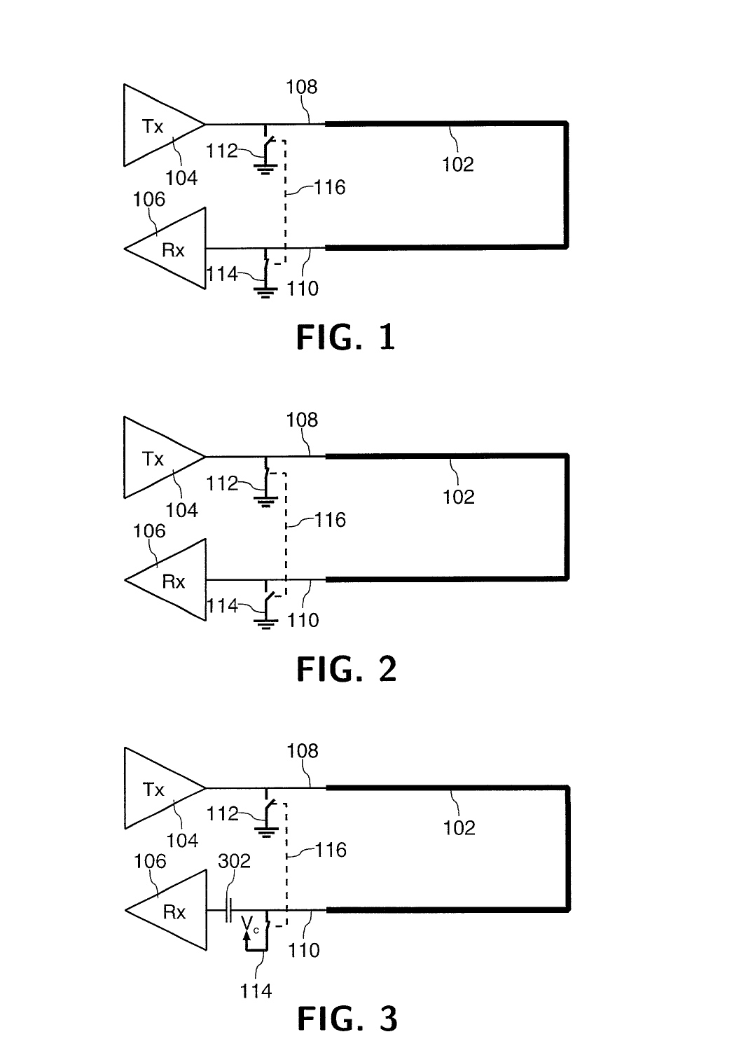

FIG. 1 is a diagram of a first embodiment of the present invention in transmit mode;

FIG. 2 is a diagram of a first embodiment of the present invention in receive mode;

FIG. 3 is a diagram of a second embodiment of the present invention in transmit mode;

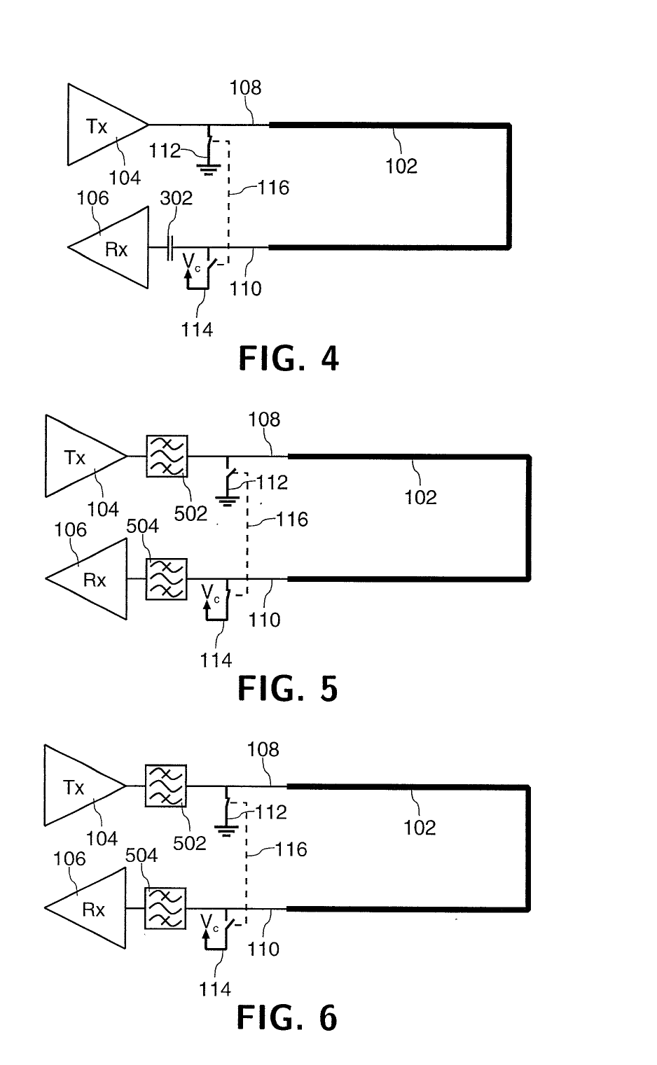

FIG. 4 is a diagram of a second embodiment of the present invention in receive mode;

FIG. 5 is a diagram of a third embodiment of the present invention in transmit mode;

FIG. 6 is a diagram of a third embodiment of the present invention in receive mode; and

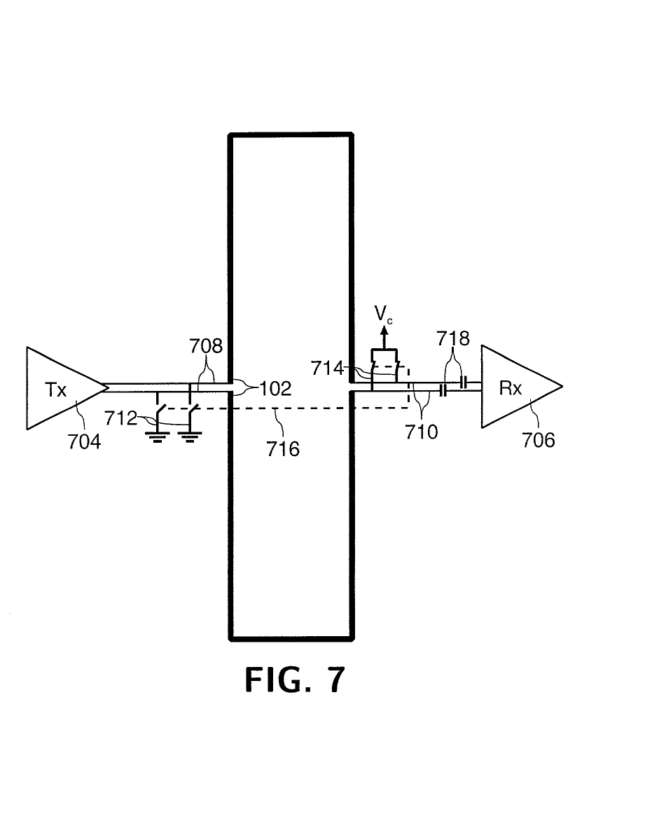

FIG. 7 is a diagram of a differential version of the second embodiment of the present invention in transmit mode.

In the drawings the same reference numerals have been used to indicate corresponding features.

Referring to FIG. 1, a first embodiment of the present invention comprises a folded monopole antenna 102 and a transceiver comprising a transmitter 104 and a receiver 106. In operation, such an antenna 102 has a signal for transmission fed into one end of the antenna while the other end is grounded. Signals from the transmitter 104 are fed via a first line 108 into one end of the antenna 102, while the signals from the other end of the antenna 102 are fed to the receiver 106 via a second line 110. First and second switches 112,114 are provided which, when closed, connect a respective one of the first and second lines 108,110 to ground. A link 116 between the switches ensures that when the first switch 112 is open the second switch 114 is closed and vice versa. As illustrated, the second switch 114 is closed, thereby grounding the second line 110 and thereby the input of the receiver 106, which therefore receives no signals. The transmitter 104 is connected to the non-grounded side of the antenna 102 which therefore transmits signals as required.

FIG. 2 shows the same embodiment but in receive mode. The first switch 112 is closed, thereby grounding the first line 108 and hence the output of the transmitter 104. The second switch 114 is open, thereby enabling signals received by the antenna 102 to be routed via the second line 110 to the input of the receiver 106.

When used in conjunction with an integrated transceiver, an arrangement in accordance with the present invention enables a reduction in the number of external (off-chip) components required. As well as a reduction in component count, the arrangement also reduces energy losses and improves signal integrity by avoiding the need for any switches in the signal flow path.

A useful modification of the first embodiment is to use the antenna 102 to provide a DC path for the output of a power amplifier included in the transmitter 104, thereby avoiding the need to provide a separate DC path for the standing current through the power amplifier output stage. A second embodiment of the present invention incorporating this modification is illustrated in FIGS. 3 (transmit mode) and 4 (receive mode). In transmit mode the second line 110 is connected via the second switch 114 to a DC supply V_{c}, which supply also acts as an earth for Radio Frequency (RF) signals. A capacitor 302 is provided to enable proper setting of DC voltage levels in the receiver 106.

In all of the above configurations, filtering and matching circuitry can be inserted as necessary. FIGS. 5 (transmit mode) and 6 (receive mode) illustrate a third embodiment of the present invention in which a transmit filter 502 is coupled between the transmitter 104 and the first line 108 and a receive filter 504 is coupled between the second line 110 and the receiver 106. The possibility of having different filter circuits in the transmit and receive signal paths is particularly useful in a frequency duplex system, in which transmitted and received signals are in different frequency bands. Because filtering provided by the filters 502,504 only needs to be adapted for one band, either transmit or receive, design of each filter is simplified and improved performance is possible. In addition the matching to the antenna 102 can be different and separately optimised for transmit and receive functions, rather than needing a broadband match.

The present invention can also be applied to a differential circuit. FIG. 7 shows a differential version of the second embodiment in transmit mode. Twin folded monopole antennas 102 are fed in differential mode from a differential transmitter 704 via first lines 708, and feed a differential receiver 706 via second lines 710. First switches 712 connect the first lines 708 to ground when closed, and second switches 714 connect the second lines 710 to the DC supply V_{c}. A link 716 between the switches 712,714 ensures that one of the pairs of switches is open when the other is closed. Capacitors 718 enable proper setting of DC voltage levels in the receiver 706.

Although the present invention has been described with reference to the use of a folded monopole antenna 102, it is equally applicable to any other antenna where connections to the transmitter 104 and receiver 106 are made to different points on the antenna structure. Changes to impedances between transmit and receive modes affect both steering of signals to/from the antenna 102 and the operation of the antenna 102 itself. In general, the antenna 102 may have more than two ports and impedance changes may be made at ports of the antenna 102 other than those through which energy is required to flow.

In particular, the present invention may be used with Planar Inverted-F Antennas in which different modes of operation are possible. Examples of suitable antennas are disclosed in our co-pending, unpublished United Kingdom patent application 0105440.2 (Applicant's reference PHGB010034).

From reading the present disclosure, other modifications will be apparent to persons skilled in the art. Such modifications may involve other features which are already known in the design, manufacture and use of transceivers, and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of features during the prosecution of the present application or of any further application derived therefrom.

In the present specification and claims the word “a” or “an” preceding an element does not exclude the presence of a plurality of such elements. Further, the word “comprising” does not exclude the presence of other elements or steps than those listed.

1. A transceiver for use in a time division system, the transceiver comprising transmitter means, receiver means, first connection means for coupling the transmitter means to a first port of an antenna and second connection means for coupling the receiver to a second port of the antenna, wherein first low impedance means are provided for coupling at least one port of the antenna to a radio frequency ground when the transceiver is operating as a transmitter and second low impedance means are provided for coupling at least one port of the antenna to a radio frequency ground when the transceiver is operating as a receiver.

2. A transceiver as claimed in claim 1, characterised in that the first impedance means comprises first switch means for coupling the second port of the antenna to a radio frequency ground when the transceiver is operating as a transmitter and in that the second impedance means comprises second switch means for coupling the first port of the antenna to a radio frequency ground when the transceiver is operating as a receiver.

3. A transceiver as claimed in claim 1, characterised in that the radio frequency ground coupled to the second port of the antenna by the first switch means further comprises a DC voltage source for supplying power to the transmitter.

4. A transceiver as claimed in claim 3, characterised in that capacitance means are coupled between the second connection means and the receiving means for setting suitable DC conditions for the receiving means.

5. A transceiver as claimed in claim 1, characterised in that at least one of the first and second connection means includes filtering means.

6. A transceiver as claimed in claim 1, characterised in that at least one of the first and second connection means includes matching means for matching the transmitting and/or receiving means to the antenna.

7. A transceiver as claimed in claim 1, constructed as a differential circuit.

8. A transceiver as claimed in claims 1, further comprising the antenna.

9. A transceiver as claimed in claim 1, implemented as an integrated circuit.
